(19) United States
(12) Patent Application Publication
(10) Pub. No.: US 2022/0270084 A1
(43) Pub. Date: Aug. 25, 2022

(54) Leveraging Non-Fungible Tokens and Blockchain to Maintain Social Media Content

(71) Applicants: Yitian Xue, Upland, CA (US); Dapeng Ma, Irvine, CA (US)

(72) Inventors: Yitian Xue, Upland, CA (US); Dapeng Ma, Irvine, CA (US)

(21) Appl. No.: 17/663,233

(22) Filed: May 13, 2022

(51) Int. Cl. G06Q 20/36; G06Q 50/00; H04L 9/08

(52) U.S. Cl. CPC G06Q 20/3678; G06Q 50/01; H04L 9/088

(57) ABSTRACT

An NFT (non-fungible token)-Blockchain remote service is implemented, which receives social media posts, content, metadata, and other data to enable content owners, sponsors, and commentators to access and market content independently from initial social media platforms. The NFT-Blockchain service may interoperate with an NFT-Blockchain application instantiated on a user's computing device (e.g., smartphone, tablet, laptop, or personal computer) or may alternatively be a plugin, such as an extension to the user's browser application. Social media posts may be retrieved from respective social media platforms, NFTized, and added to a blockchain to establish the immutability and marketability of the post. A main system wallet associated with the NFT-Blockchain service may be established and utilized to receive money transfers from owners for the NFTization of their posts and compensation for other administrative tasks, such as NFT transfers.

### BACKGROUND

Users of Social media platforms, such as Twitter®, LinkedIn®, Facebook®, YouTube®, and the like, are restricted by the specific platform's regulations and censorship. Furthermore, the regulated and censored posts or comments may not be stored permanently outside these platforms. As non-fungible tokens (NFTs) and blockchain continue developing in society, their integration with social media platforms may increase user experiences and streamline collaboration.

### SUMMARY

An NFT (non-fungible token)-Blockchain remote service is implemented, which receives social media posts, content, meta data, and other data to enable content owners, sponsors, and commentators to access and market content independently from initial social media platforms. The NFT-Blockchain service may interoperate with an NFT-Blockchain application instantiated on a user's computing device (e.g., smartphone, tablet, laptop, or personal computer) or may alternatively be a plugin, such as an extension to the user's browser application.

Social media posts may be retrieved from respective social media platforms, NFTized, and added to a blockchain to establish the immutability and marketability of the post. A main system wallet associated with the NFT-Blockchain service may be established and utilized to receive money transfers from owners for the NFTization of their posts and compensation for other administrative tasks, such as NFT transfers.

Furthermore, sponsors who are compensated for making sponsorship posts on behalf of a brand for advertising may have their social media posts NFTized onto the NFT-Blockchain service. The developed NFT may be automatically transferred to the owner (e.g., the brand owner) or held by the system's main wallet until the owner claims ownership. In such sponsored post situations, the NFT owner may compensate the system's main wallet for transfer fees and administration fees. Assuming the NFT is not for sale or the user does not want to participate any further on the blockchain and NFT marketplace, the token's sponsor- or owner-created NFTs of social media posts may be set to “hold” to show the public that the post is not for sale and/or the user no longer wishes to participate in the marketplace.

NFTs may be acquired, claimed, or transferred using the NFT-Blockchain service. For example, when a wallet owner associated with a social media post seeks to acquire ownership rights over their social media post, they can submit a request to the NFT-Blockchain service. The owner may be prompted to submit proof of ownership over the social media post, which may include login credentials that interoperate with the social media platform's authentication service, submitting proof of identification (e.g., license, passport, etc.), or other means that may provide proof of identity.

Current owners over social media posts or comments may alternatively set an NFT to “transferrable” and also set a price for the NFT. This will be publicly viewable on third-parties user interfaces to enable offers. Respective wallet owners may then make offers to purchase the transferrable NFT. Responsive to a purchase, the current NFT owner may modify the historical information and transfer log associated with the NFT to solidify its immutability. Such transactions may be added to the blockchain for immutability and records. Other functionality provided by the NFT-Blockchain service includes user control over NFT transfer status, whether to incorporate social media comments, and whether to enable or disable comments on an NFT (outside of the social media platform's censorship and regulations).

The present NFT-Blockchain marketplace and system provides dynamicity, increased user experience and control, and detracts from separate platforms' censorship and regulations for social and public opinions and comments. Users are invited to participate in the free trade of ideas without being tied to a specific social media platform's agenda or rules, while simultaneously being able to sell such rights to those ideas. Rights over social media posts and comments are secured via the NFT-Blockchain service's security and ownership configurations, and transfer, acquiring, and claiming NFTs are tied to system configurations that are not tied to third-party social media platforms. Such configurations improve user experiences and provide a unique user interface for exchanging NFTs in the social media space.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from reading the following Detailed Description and reviewing the associated drawings.

### BRIEF DESCRIPTION OF THE DRAWINGS

FIG. 1 shows an illustrative layered architecture of a computing device that may be used for a non-fungible token (NFT)-Blockchain application;

FIG. 2 shows an illustrative diagram in which various social media services provide social media posts to an NFT-Blockchain service;

FIG. 3 shows an illustrative schema of social media posts, metadata, and other data that may be transferred from the social media services to the NFT-Blockchain service;

FIG. 4 shows an illustrative diagram of the NFT-Blockchain service parsing social media posts into categories;

FIG. 5 shows an illustrative diagram of how social media posts are associated with an owner, sponsor, or comment;

FIG. 6 shows an illustrative representation of an initial social media post associated with an owner;

FIG. 7 shows an illustrative representation of a comment being associated with a sponsor;

FIG. 8 shows an illustrative representation of a social media application operating on a user's mobile device;

FIG. 9 shows an illustrative representation in which a social media post is minted into an NFT;

FIG. 10 shows an illustrative representation in which the social media post is NFTized into a token and incorporated into a blockchain;

FIG. 11 shows an illustrative schema of social media posts and other data that may be associated with the created NFT;

FIG. 12 shows an illustrative environment of a user requesting an NFT from the original or current owner;

FIG. 13 shows an owner claiming ownership over an NFT from the system main wallet at the NFT-Blockchain service;

FIG. 14 shows an illustrative environment showing the transfer status functionality;

FIG. 15 shows an illustrative environment showing the incorporating social comments functionality;

FIG. 16 shows an illustrative environment showing a user enabling or disabling comments functionality;

FIG. 17 shows an illustrative environment of a user's comment being minted or sponsored;

FIG. 18A shows an illustrative environment of the user's comment being NFTized and incorporated into the blockchain;

FIG. 18B shows an illustrative representation in which comments hidden from the NFT marketplace by the post owner are immutably maintained on the blockchain;

FIG. 19 shows an illustrative representation of a blockchain that may be associated with a single or multiple social media platforms;

FIGS. 20-23 shows illustrative processes implemented by one or more of the NFT-Blockchain service, the social media services, or the user computing devices;

FIG. 24 is a simplified block diagram of an illustrative architecture of a computing device that may be used at least in part to implement the present leveraging of non-fungible tokens and blockchain to maintain social media content; and

FIG. 25 is a simplified block diagram of an illustrative remote computing device, remote service, or computer system that may be used in part to implement the present leveraging non-fungible tokens and blockchain to maintain social media content.

Like reference numerals indicate like elements in the drawings. Elements are not drawn to scale unless otherwise indicated.

### DETAILED DESCRIPTION

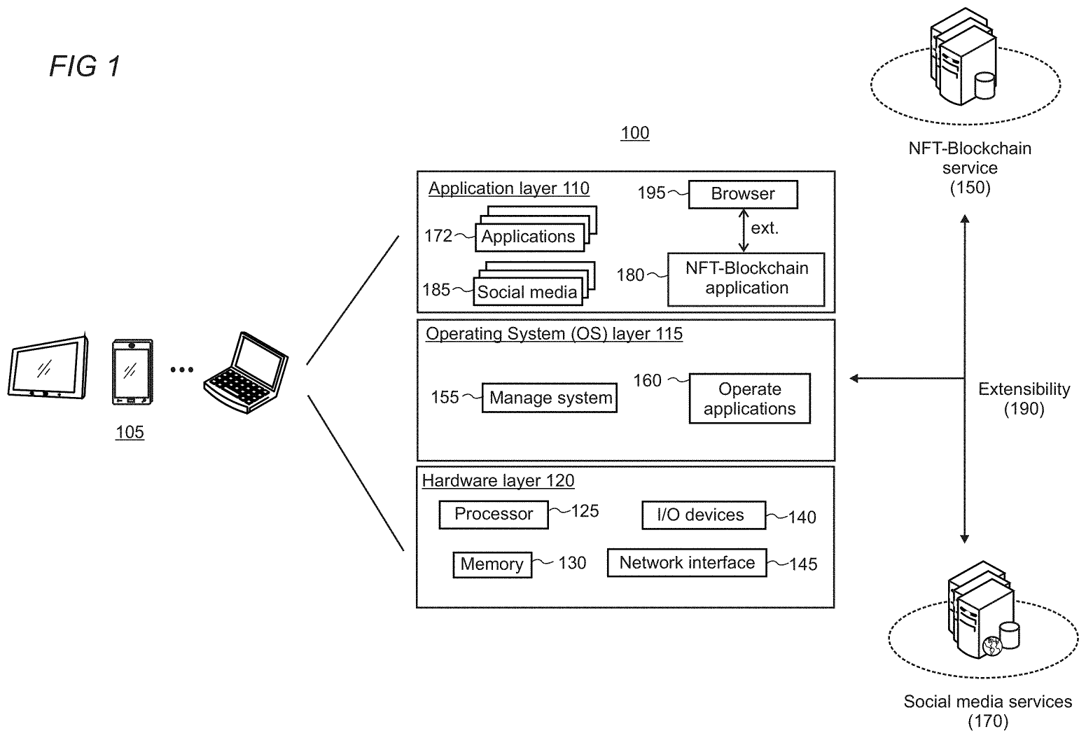

FIG. 1 shows a simplified layered architecture 100 of a computing device 105, such as a mobile device, smartphone, tablet, laptop, etc., that may implement some of the features described herein. The computing device 105 can include a hardware layer 120, operating system (OS) layer 115, and application layer 110. The hardware layer 120 provides an abstraction of the various hardware used by the computing device 105 (e.g., input and output devices, networking and radio hardware, etc.) to the layers above it. In this illustrative example, the hardware layer supports processor(s) 125, memory 130, input/output devices (e.g., keyboard, display screen, touchscreen display, microphone, speaker, etc.) 140. The vehicle can include a network interface 145, such as a network interface card (NIC), enabling a wireless connection to the Internet. The network interface may work with a cellular connection to a cell tower or utilize Wi-Fi to connect to the Internet. The network interface can enable the computing device to communicate with remote services, such as the NFT-Blockchain service 150 and social media services 170, among other services.

In some implementations, the vehicle can support short-range communications over Bluetooth® or NFC (Near Field Communication), such as to a user's computing device or other vehicles.

The application layer 110 in this illustrative example supports various applications 172, including social media applications 185 (e.g., Twitter®, Facebook®, LinkedIn®, etc.), a browser 195, and an NFT-Blockchain application 180 that may communicate with the NFT-Blockchain service 150. In this regard, the computing device 105 may have extensibility 190 to various remote services to interoperate therewith. The NFT-Blockchain application may be a standalone application and/or a plugin to another application on the computing device, such as an extension to the browser 195. The NFT-Blockchain application can provide the user interface (UI), so the user can manage and control, purchase, and transfer, among other functionality, social media posts that have been NFTized (non-fungible tokenized). NFTized signifies that a social media post or comment has been minted and turned into an NFT and associated with a blockchain.

Although only certain applications are depicted in FIG. 1, the computing device 105 can utilize any number of applications 172. The applications are often implemented using locally executing code. In some cases, however, these applications can rely on services and/or remote code execution provided by remote servers or other computing platforms such as those supported by a service provider or other cloud-based resources. The computing device 105 may be configured with extensibility 190 to remote services or other computing devices, such as by using its network interface 145.

The OS layer 115 supports, among other operations, managing system 155 and operating applications/programs 160. The OS layer may interoperate with the application and hardware layers in order to perform various functions and features.

The NFT-Blockchain application 180 and the NFT-Blockchain service 150 utilize a blockchain with which NFTs are associated. The blockchain is a shared, immutable ledger that facilitates the process of recording transactions and tracking assets in a network. Depending on the implementation, the asset can be tangible (e.g., a house, car, cash, land) or intangible (intellectual property, patents, copyrights, branding). In this implementation, the asset may be social media posts and comments from users operating one or more social media applications 185. Like other assets, the social media posts and comments can be tracked on a blockchain network, thereby creating a referential ledger independent of censorship and regulations of specific social media platforms while also enabling the purchase and ownership transfer of the NFTized social media post or comment.

The NFT-Blockchain service 150 may utilize extensibility to the social media services 170 to retrieve posts, comments, and multimedia, among other data. As each social media post or comment to a social media platform occurs and is received at the NFT-Blockchain service, the post/comment is minted into an NFT and is recorded as a “block” of data on the blockchain on the NFT-Blockchain service. The blocks may be individually maintained and verified by a plurality of user devices operating on the NFT-Blockchain service, such as computing devices 105.

The blockchain can be a public or private blockchain. In a public blockchain network, anyone (or device) may be free to join and participate and is often referred to as permissionless. While private blockchain networks are typically known as permissioned networks, public blockchains may also be permissioned and have some rules for participants to join. As one example, a public blockchain network may restrict particular computing devices together. Other types of permissions for a blockchain network may be user criteria (e.g., age, location, demographics, etc.).

The data block can record data and metadata associated with the social media posts and comments, as discussed in greater detail below. Such blocked information can be customized based on the proprietary design and customizations of the NFT-blockchain application 180 and NFT-Blockchain service 150. Each block may be created based on a given consensus protocol utilized by the blockchain application and service. Exemplary blockchain applications can include Proof of Work (PoW), Proof of Stake (PoS), Proof of Activity (PoA), Practical Byzantine Fault Tolerance (PBFT), and selective endorsement. The specific consensus protocol depends on the implementation.

The social media posts and comments are blocked together in an irreversible chain: a blockchain. Each additional block strengthens the verification of the previous block and hence the entire blockchain. This renders the blockchain tamper-evident for each computing device that analyzes the individual transaction blocks to achieve a consensus, thereby establishing immutability. This removes the possibility of tampering by a malicious actor—and builds a ledger of transactions that network members (e.g., social media users) can trust. Furthermore, providing the social media posts and NFTs streamlines an owner's ability to own their comments and transfer them to interested members for a fee.

Like a public blockchain network, a private blockchain network is a decentralized peer-to-peer network. However, one defined organization governs the network in a private blockchain, thereby enabling control over who is allowed to participate (e.g., which user devices are invited), execute a consensus protocol (e.g., PoW, PoS, etc.), and maintain the shared ledger. Depending on the use case, this can significantly boost trust and confidence between participants. A private blockchain can be run behind a corporate firewall and even be hosted on-premises, thereby providing even greater protection.

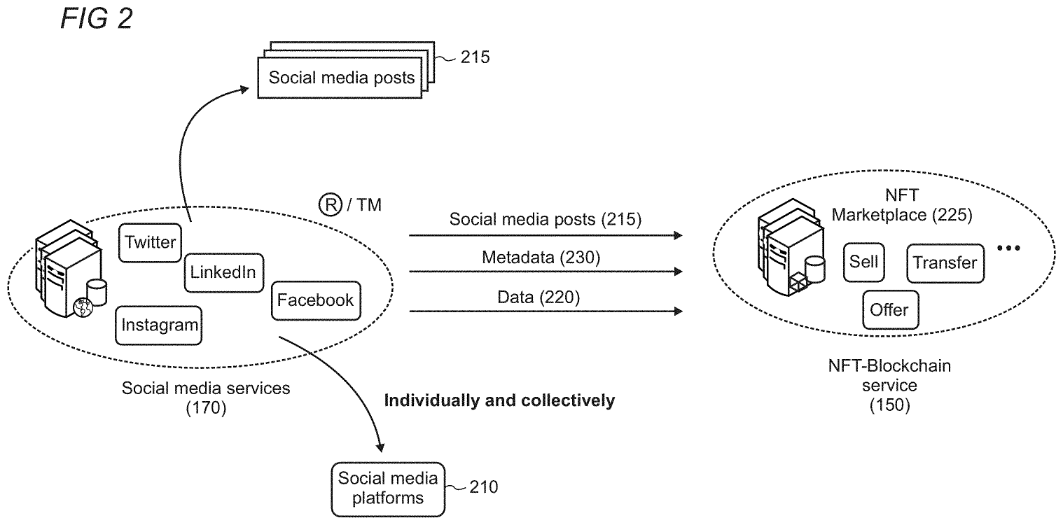

FIG. 2 shows an illustrative environment in which data from social media platform 210 are transmitted to and received by the NFT-Blockchain service 150. The various social media platforms can include Twitter®, LinkedIn®, Facebook®, and Instagram®, YouTube®, among other platforms, which are hosted by respective social media services 170. The various social media applications are referenced herein individually and collectively as “social media platforms” 210. Each social media platform has its own set of data, including at least social media posts 215, which can include original posts or comments on a post. The Social media posts, metadata, and other data 220 are transmitted to and received by the NFT-Blockchain service 150 for processing and ultimately enter the NFT-Blockchain marketplace 225 of social media NFTs.

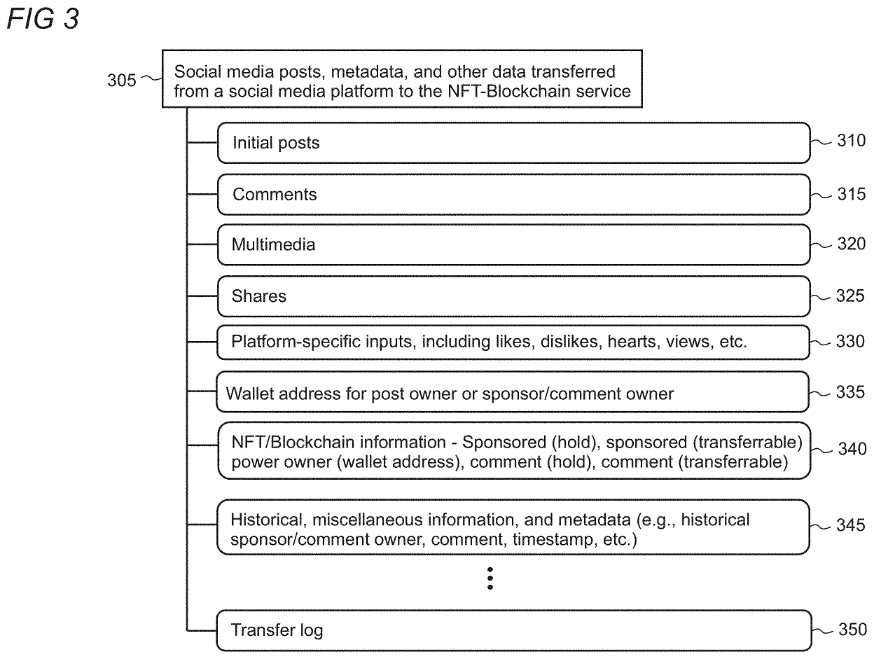

FIG. 3 shows an illustrative schema of information that may be transmitted from social media services 170 to the NFT-Blockchain service 150, as representatively shown by numeral 305. Non-exhaustive data that may be transmitted includes initial posts 310, comments 315, multimedia 320, shares, 325, platform-specific inputs, including likes, dislikes, hearts, views, etc. 330, wallet address for post owner or sponsor/comment owner 335, NFT/blockchain information (e.g., sponsored (hold or transferrable), post owner and wallet address, comment (hold or transferrable) 340, historical and miscellaneous information (e.g., historical sponsor/comment owner, comment, timestamp, etc.) 345, and transfer log 350, among other information.

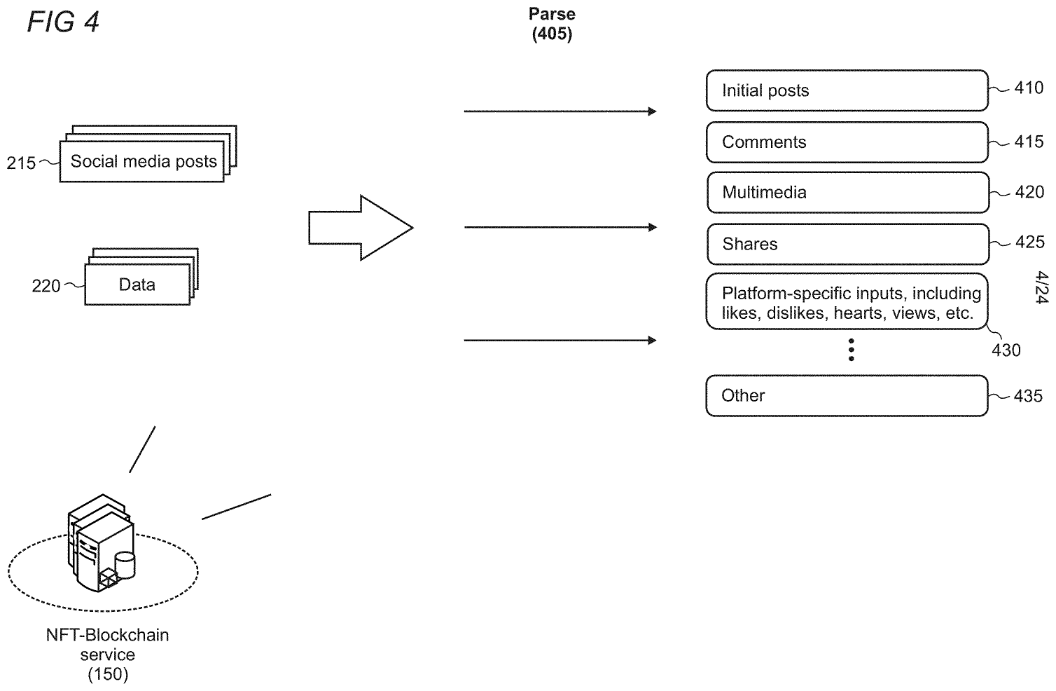

FIG. 4 shows an illustrative environment where the NFT-Blockchain service 150 parses the social media posts 215 and other data 220 into categories, as referenced by numeral 405. For example, social media posts may be categorized as an initial post 410, comment 415, multimedia 420, shares 425, platform-specific inputs, including likes, dislikes, hearts, views, etc. 430, among other categories 435.

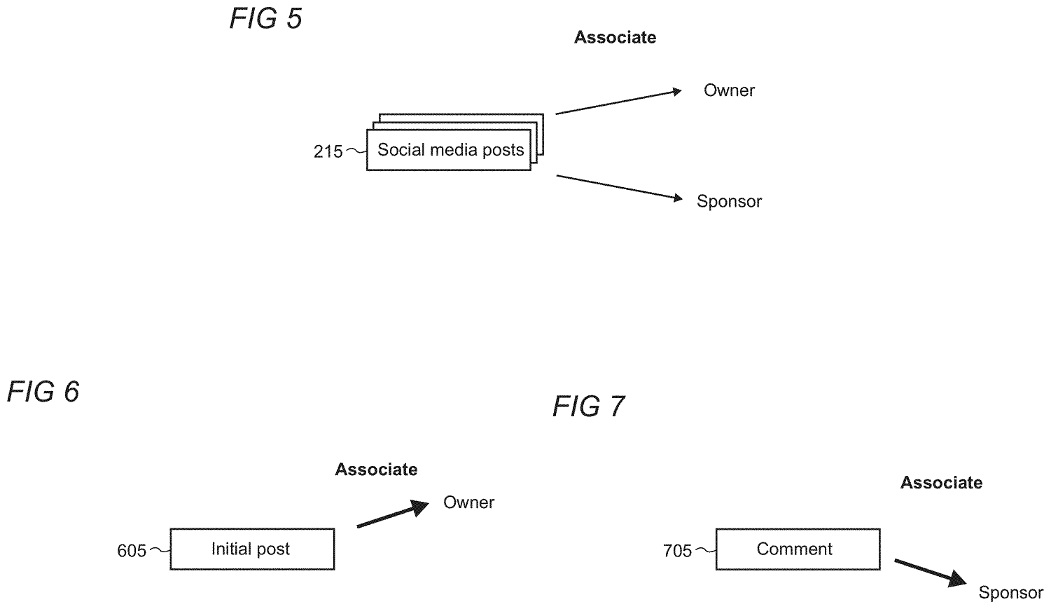

FIG. 5 shows an illustrative representation in which the social media posts may also be associated with an owner or sponsor. For example, a social media account owner may create a post personally (or on behalf of a brand), or a sponsor may create a post for marketing or other purposes on behalf of a brand or company. Sponsors, such as social media influencers may receive compensation for creating a post for a brand to drive traffic to that brand. FIGS. 6 and 7 show illustrative representations in which an initial 605 is associated with an owner and a comment 705 is associated with a sponsor, respectively. Additionally, initial posts may be associated with a sponsor, and comments may be associated with owners.

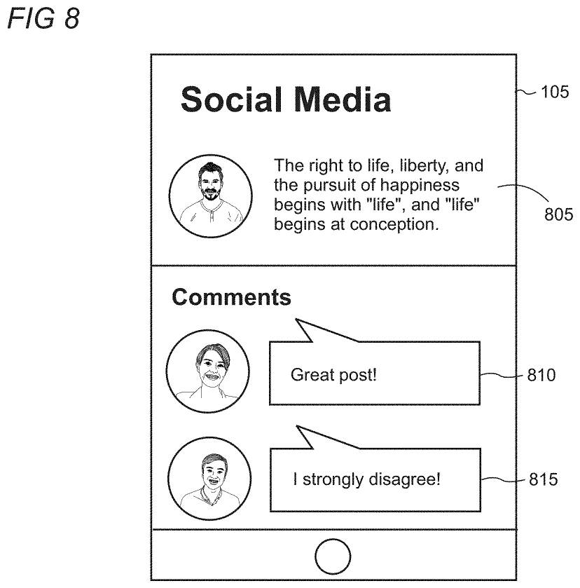

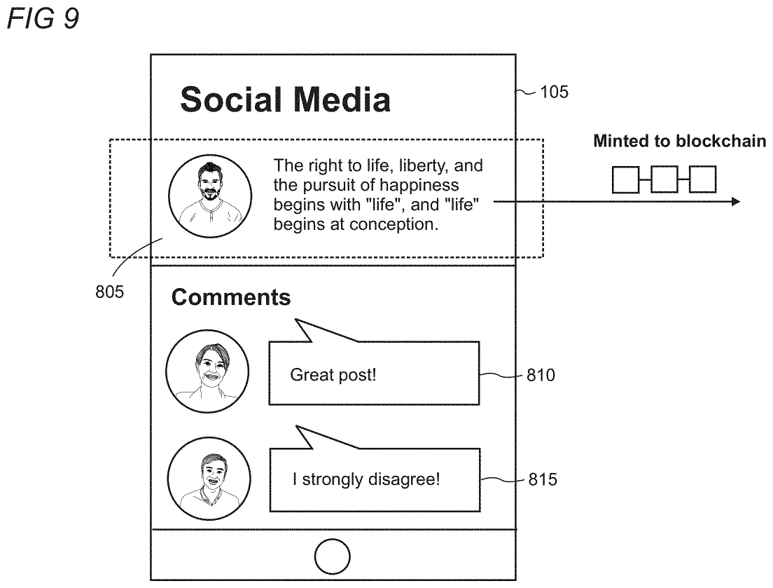

FIG. 8 shows an illustrative user interface on a computing device 105 in which a user-created social media post 805 on their social media application 185. A couple of comments 810, 815 are shown beneath the post as well. The poster may be a sponsor for a brand or other person or may be the owner. FIG. 9 shows an illustrative representation in which the social media post 805 is minted to a blockchain by the NFT-Blockchain service 150. Although an initial social media post is shown as being minted in FIG. 9, other pieces of data from the social media platforms 210 (FIG. 2) may also be minted, such as the parsed and identified items shown in FIG. 4.

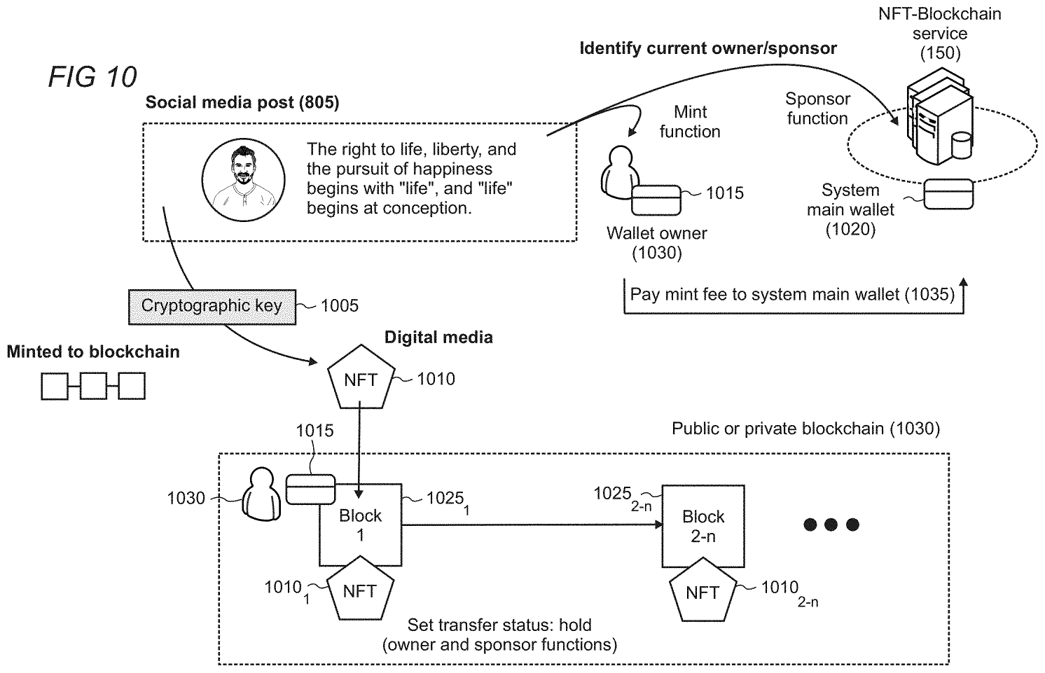

FIG. 10 shows an illustrative environment where the NFT-Blockchain service 150 NFTizes the social media post 805. To “NFTize” a social media post, comment, multimedia (e.g., picture, video, and audio file, etc.) or any combination thereof signifies creating, or “minting,” a digital asset or file from some object, which in this case is social media data. The terms “minting” or “NFTizing” a social media post may be used interchangeably herein. The minted NFT can be traded, purchased, or otherwise transferred from one owner's wallet to another. In this regard, each NFTized social media post may be owned and associated with a unique user's wallet or alternatively may be owned by a system wallet 1020 associated, for example, with the NFT-Blockchain service 150. Associating NFTs with the system wallet 1020 enables an owner to claim ownership over a post at some future date. A crypto key is used to create a token on the blockchain that represents the piece of digital media. Here, cryptographic key 1005 is applied to the social media post 805 to create the NFT (non-fungible token) 1010, which represents digital media.

In the present system, when a social media post is minted, such as social media post 805, the NFT-Blockchain service 150 may identify the current owner or sponsor associated with the NFT. The wallet owner 1030 may own wallet 1015, which may be associated with a given cryptocurrency utilized by the platform (e.g., Bitcoin, Ethereum, Dogecoin, etc.). The NFT-Blockchain service may utilize a mint function which causes the service to associate the created NFT with the wallet owner 1030. Verifying the owner may work by, for example, users creating an account with the NFT-Blockchain service 150 and then associating their NFT-Blockchain account with one or more of their social media platforms 210 accounts (FIG. 2). For example, the NFT-Blockchain service may prompt the user to enter their login credentials for a respective social media platform so the service can verify the user's identity. Other authentication methods are also possible, such as prompting the user to provide identification, etc.

The wallet owner 1030 may pay a minting fee to the system main wallet 1020 to utilize its marketplace, as representatively shown by numeral 1035. Alternatively, a sponsor function may cause the NFT-Blockchain service may associate control/ownership over the minted NFT 1010 to the service 1050. In this scenario, the wallet owner may pay the system main wallet to receive its NFT, as discussed in greater detail below.

Depending on the implementation, the created NFT 1010 is applied to a public or private blockchain 1030. The NFT is represented as a block 1025 on the blockchain, which creates an immutable ledger of the transaction and its details, such as the NFT data (e.g., social media post content), timestamp, etc. The blockchain continues onto a second and subsequent block 1025, each of which represents a unique NFT. Blocks on the blockchain grow by additional social media posts being minted or when a wallet owner over one NFT transfers ownership to another wallet owner. Whether the mint or sponsor function is utilized, the created NFT-Blockchain service and the respective user's NFT-Blockchain application 180 may set the NFT's transfer status to “hold” so that no transfers can occur. Alternatively, when the appropriate and verifiable owner over the minted NFT (i.e., the person who posted the social media content is the wallet owner), then the user may customize their local application to set transfer statuses to “transferrable.”

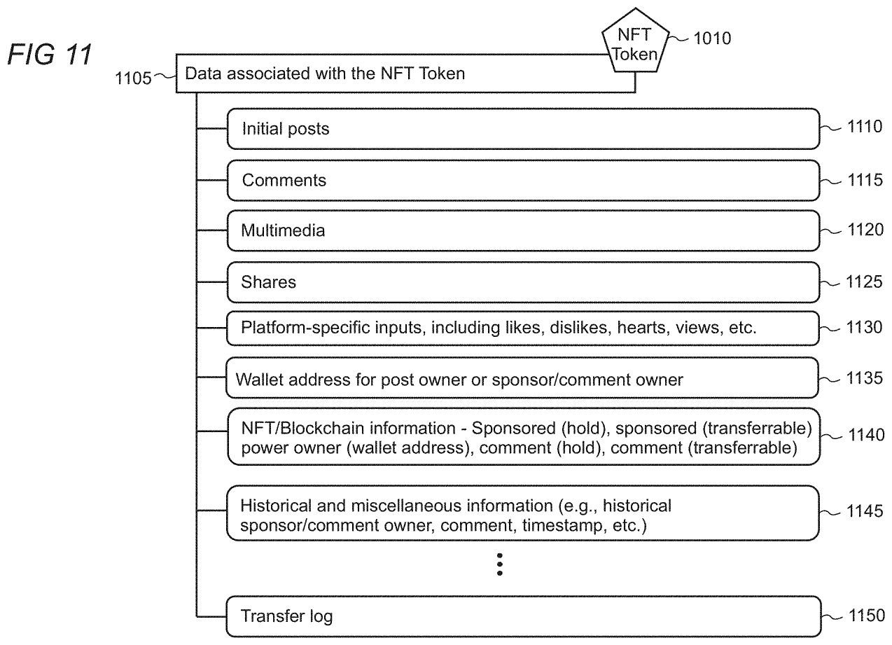

FIG. 11 shows an illustrative schema of information that may be associated with each minted NFT on the public or private blockchain 905, as representatively shown by numeral 1105. Non-exhaustive data that may be associated with created NFTs include initial posts 1110, comments 1115, multimedia 1120, shares, 1125, platform-specific inputs, including likes, dislikes, hearts, views, etc. 1130, wallet address for post owner or sponsor/comment owner 1135, NFT/blockchain information (e.g., sponsored (hold or transferrable), post owner and wallet address, comment (hold or transferrable) 1140, historical and miscellaneous information (e.g., historical sponsor/comment owner, comment, timestamp, etc.) 1145, and transfer log 1150, among other information.

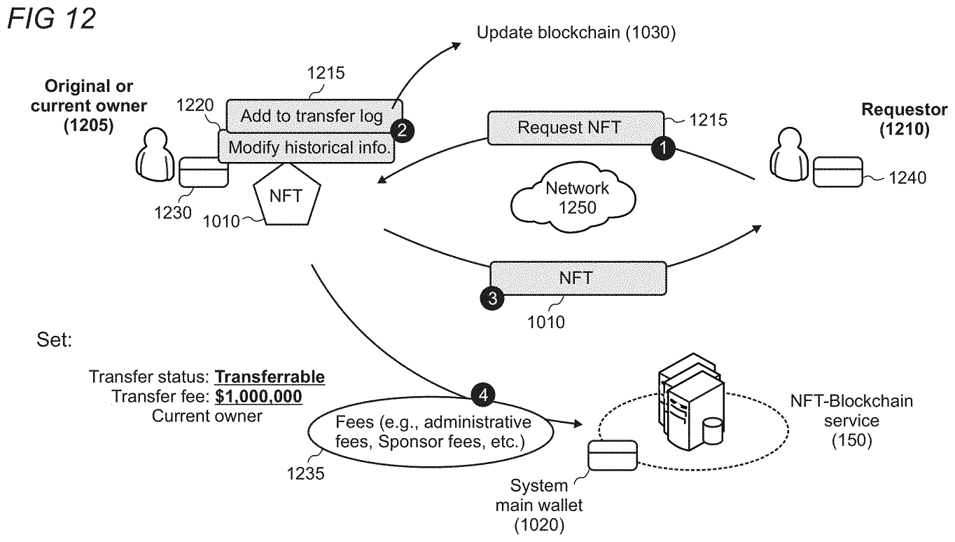

FIG. 12 shows an illustrative environment where a minted NFT 1010 is transferred from an original or current owner's wallet 1230 to a requestor's wallet 1240. The interactions shown may be performed through the NFT-Blockchain service 150, each user's local NFT-Blockchain application 180, and/or through a browser or other plugin application operating on the respective user devices. Initially, the original or current owner may, using their NFT-Blockchain application 180 or otherwise through accessing the NFT-Blockchain service 150, set the transfer status to the NFT to “Transferrable,” and a price for purchasing, which will be viewable by the public in the marketplace operated by the service 150.

The requestor 1210 transmits a request for the NFT 1215 over network 1250 to the original or current owner 1205. The network may include any one or more of a local area network, wide area network, the Internet, or worldwide web. The requestor may have an established account with the NFT-Blockchain service 150 and may use a locally instantiated NFT-Blockchain application 180 or a web browser to submit the request. The requestor may also have some cryptocurrency within their wallet to pay any administrative fees. The original owner may be the person who made the NFTized social media post or is the brand owner for a sponsored social media post. While the current owner may be the original owner, the current owner may also be a subsequent owner who purchased or otherwise previously received the transferred NFT.

Upon receiving the request for the NFT 1215, the original or current owner 1205 may accept or reject the offer. Rejecting the offer will result in no NFT transfer and may result in a notification to the requestor's computing device that the offer was denied. Upon accepting the offer, a new block on the blockchain may be created and written. On the new block, the historical information may be modified 1220, and the transaction may be added to the transfer log 1215 so that information about the NFT is permanently stored and viewable in the blockchain's ledger. The original or current owner's wallet 1230 may subsequently transfer the NFT 1010 to the requestor's wallet 1240. Furthermore, various fees may be paid to the NFT-Blockchain service's system main wallet 1020 for operating the marketplace, such as administrative fees, sponsor fees, etc., as representatively shown by numeral 1235. The transfer will be logged as another and subsequent block in the blockchain 1030.

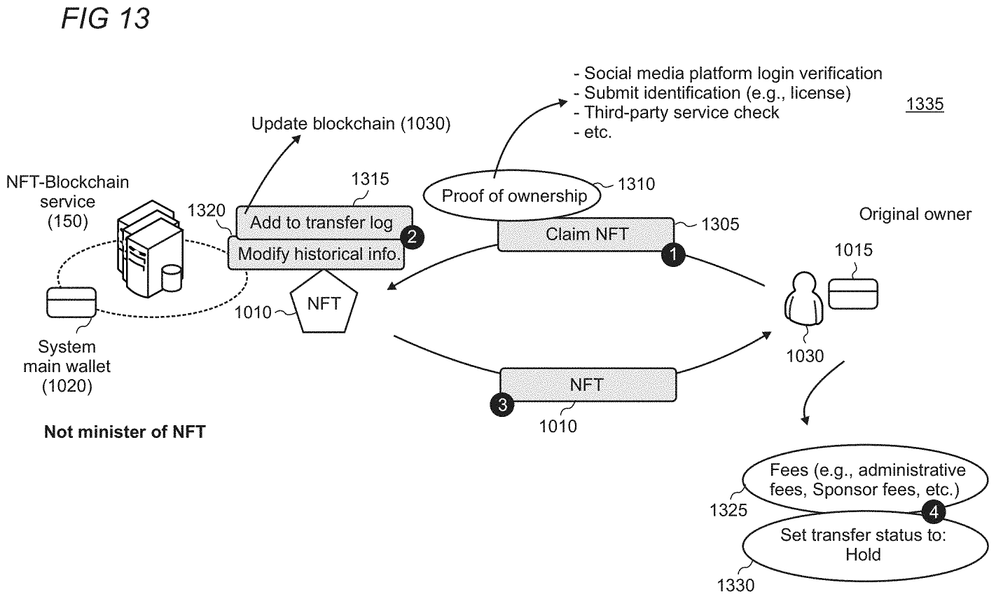

FIG. 13 shows an illustrative environment in which the original owner 1030 of the NFT 1010 submits a claim for the NFT 1305 to the NFT-Blockchain service 150, which is currently hosted by the system main wallet 1020. As shown, the NFT-Blockchain service is not the minister of the NFT and thus, is configured to transmit NFTs to their proper owner. The NFT-Blockchain service may request proof of ownership 1310 to the original owner 1030, including social media platform login verification, submitting identification (e.g., license), third-party service check, etc., as representatively shown by numeral 1335. Upon verifying the original owner's identity and ownership over the social media post (e.g., post 805 in FIG. 8), the NFT-Blockchain service's system main wallet 1020 adds the transfer to the transfer log associated with the NFT 1315, modifies the historical information 1320, and then transfers the NFT to the original owner's wallet. Such transfer log, historical information, and updated ownership information is logged as a new block on the blockchain. The transfer will be logged as another and subsequent block in the blockchain 1030. The original owner may have to pay administrative fees and sponsor fees 1325 associated with the transfer, and the user's local NFT-Blockchain application 180 may set transfer status to “Hold,” or the NFT-Blockchain service may automatically do so.

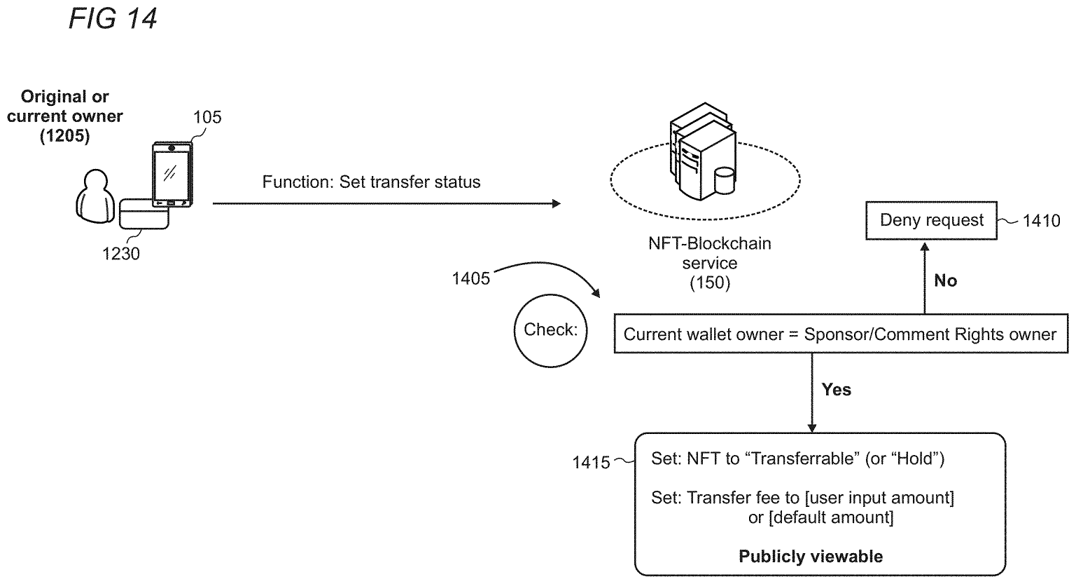

FIGS. 14-16 show various executable functions that may be performed by the NFT-Blockchain service 150, whether responsive to user input or not. In FIG. 14, the original or current owner 1205, operating the NFT-Blockchain application 180 or a web browser on computing device 105, may set a transfer function to an NFT. Responsive to receiving the request, the NFT-Blockchain service 150 may check whether the current wallet owner is the same as the sponsor/comment rights owner, as representatively shown by numeral 1405. A failed authentication check may result in the service denying the request 1410. A successful authentication check may result in the service modifying the NFT's characteristics based on the owner's input, as representatively shown by numeral 1415. For example, the user may set the NFT's transfer status to “Transferrable” or “Hold,” and the user may set a transfer fee to some desired amount, or the system may enter some default amount. This information would be publicly viewable so that other users in the NFT-Blockchain service's marketplace can make offers for NFTs. For example, the updated transfer status may be stored at the NFT-Blockchain service and thereby viewable by other users accessing the marketplace.

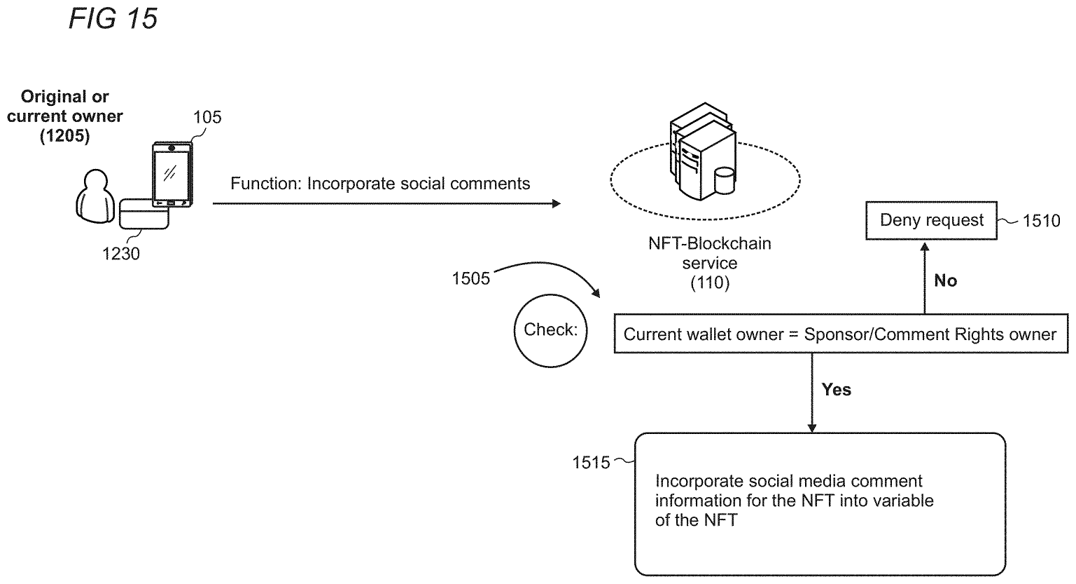

In FIG. 15, the original or current owner 1205, operating the NFT-Blockchain application 180 or a web browser on computing device 105, may utilize a function to incorporate social comments into the NFTized social media post. Responsive to receiving the request, the NFT-Blockchain service 150 may check whether the current wallet owner is the same as the sponsor/comment rights owner, as representatively shown by numeral 1505. A failed authentication check may result in the service denying the request 1410. A successful authentication check may result in the service modifying the NFT's characteristics based on the owner's input, as representatively shown by numeral 1515. For example, the user may select to incorporate social media comment information for the NFT into a variable for the NFT.

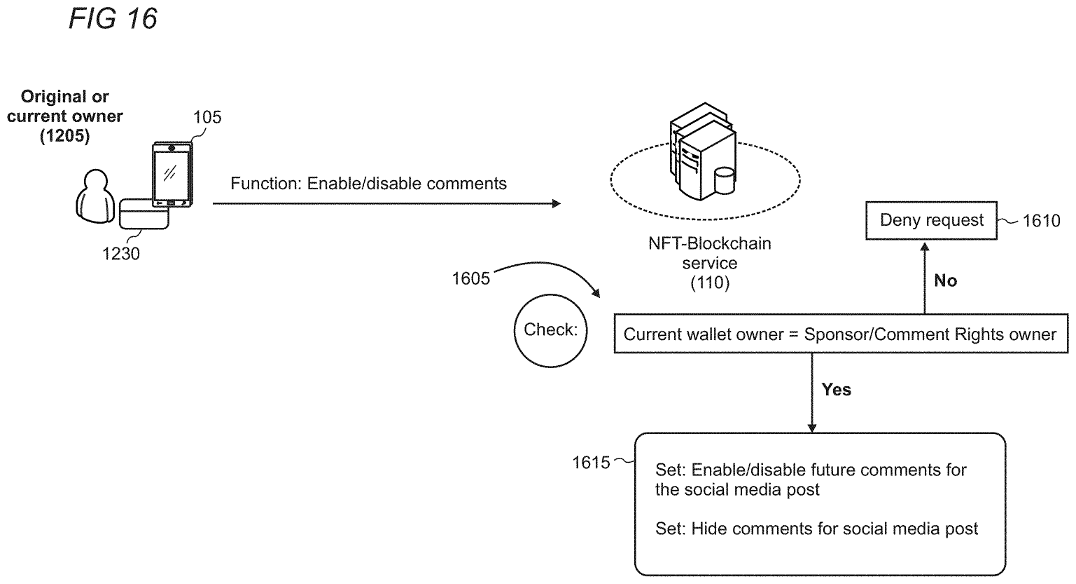

In FIG. 16, the original or current owner 1205, operating the NFT-Blockchain application 180 or a web browser on computing device 105, may utilize a function to either enable or disable comments on the NFTized social media post. Responsive to receiving the request, the NFT-Blockchain service 150 may check whether the current wallet owner is the same as the sponsor/comment rights owner, as representatively shown by numeral 1605. A failed authentication check may result in the service denying the request 1610. A successful authentication check may result in the service enabling or disabling comments for the NFT social media post or setting the comments to be hidden, as shown by numeral 1615.

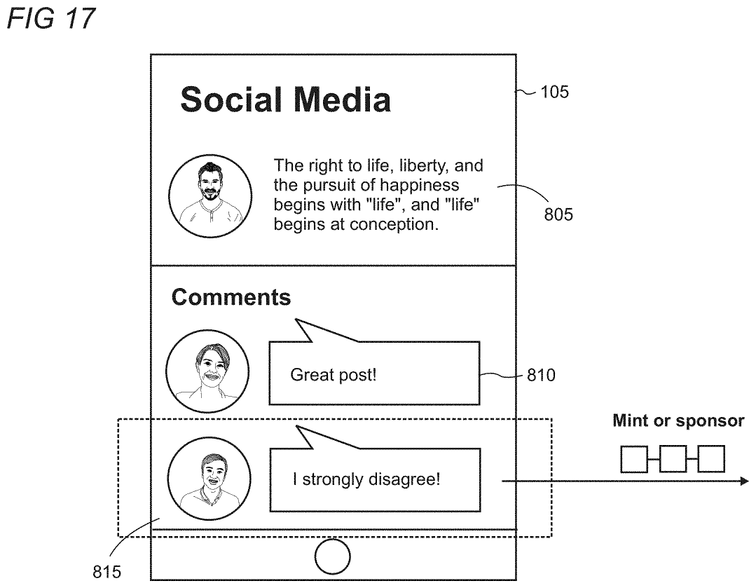

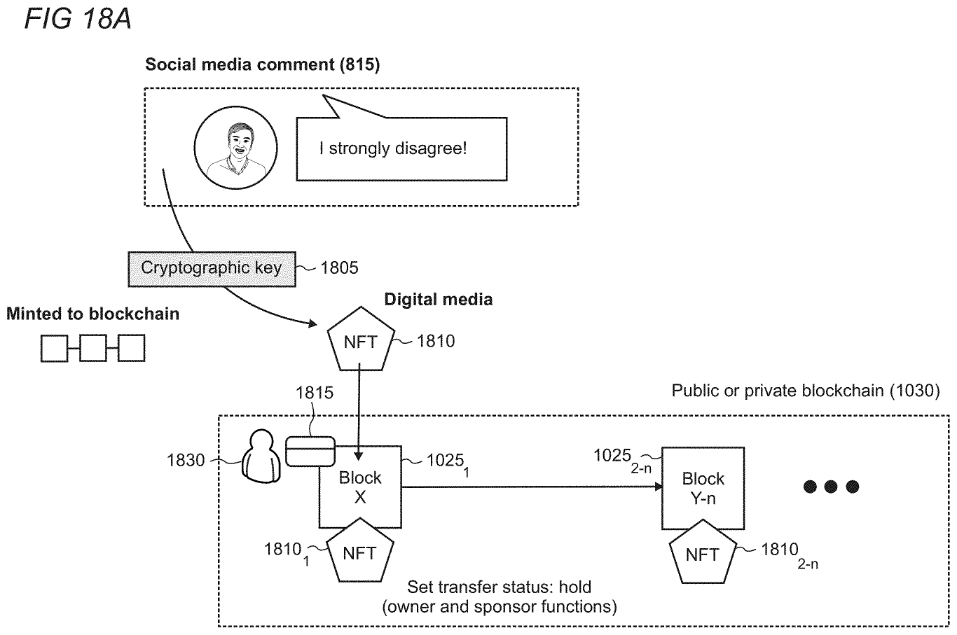

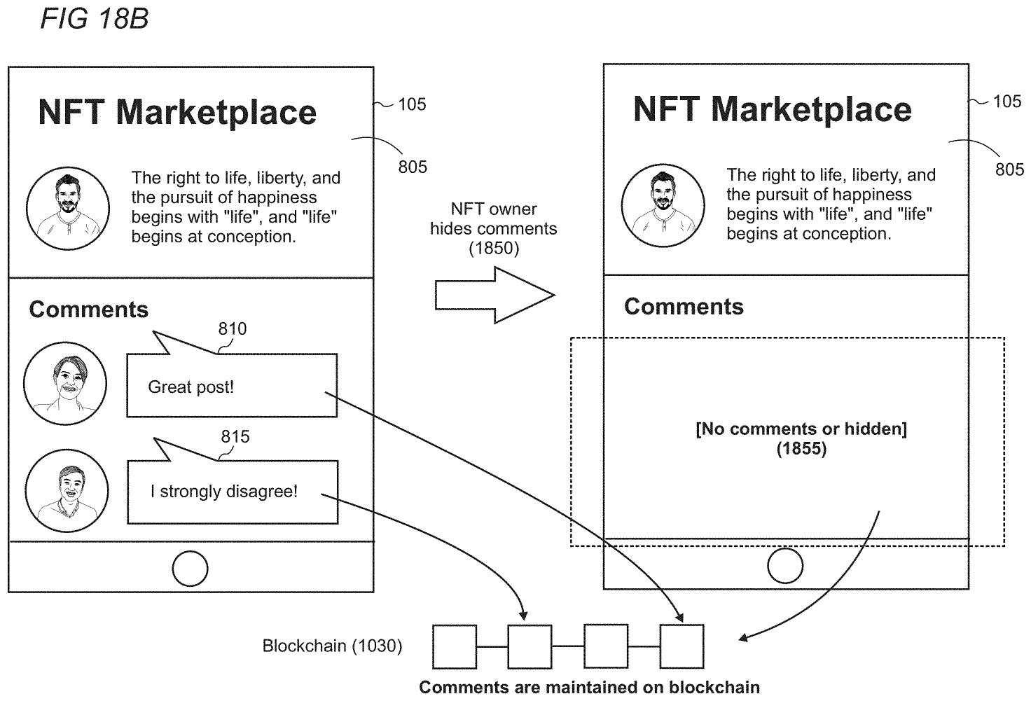

FIG. 17 shows an illustrative representation in which a comment 815 under the social media post 805 (FIGS. 8-9) is minted into an NFT for recording onto the blockchain. As shown in FIG. 18 and similar to minting the social media post, a cryptographic key 1805 may be applied to the social media comment 815 to create the NFT 1810. The created NFT is placed on the public or private blockchain 1030. Similar data may be associated with the NFT, as shown and described with respect to FIG. 11. The NFT may be associated with the commentator's wallet 1815 associated with the owner-user 1830. The created block may be the next block in the blockchain, which is shown as Block X, and the blockchain may continue from the subsequent block and onward, which is shown as Block Y-n. In typical implementations, only original or initial social media posts may be minted on the blockchain, and comments may be tied to that NFT. Alternatively, however, comments underneath initial posts may also be minted and placed on the blockchain.

FIG. 18B shows an illustrative representation in which an NFT owner decides to hide comments to their social media post 805, as representatively shown by numeral 1850. The user may NFT-Blockchain application 180 may have a user interface that enables a user to select to hide comments from their social media post. This may be in the form of a radio button, swiping motion on the user interface's touchscreen display, etc.

Upon selecting to hide the comments, the comments 810, 815 under the post 805 may be hidden, as representatively shown by numeral 1855 on the right display in FIG. 18B. However, the blockchain maintains the comments to ensure that comments are trackable and that freedom of speech is maintained. Thus, the hide or delete comment feature is focused on hiding comments from the NFT marketplace's user interface, but the blockchain can still be inspected for the comments. While the immutability of posts and comments is illustrated above, other data from the social media platforms 210 are also NFTized and saved to the blockchain, such as multimedia, shares, and other data shown in FIG. 3. Thus, any such data deleted, such as “likes,” may be hidden from the NFT marketplace but maintained on the blockchain.

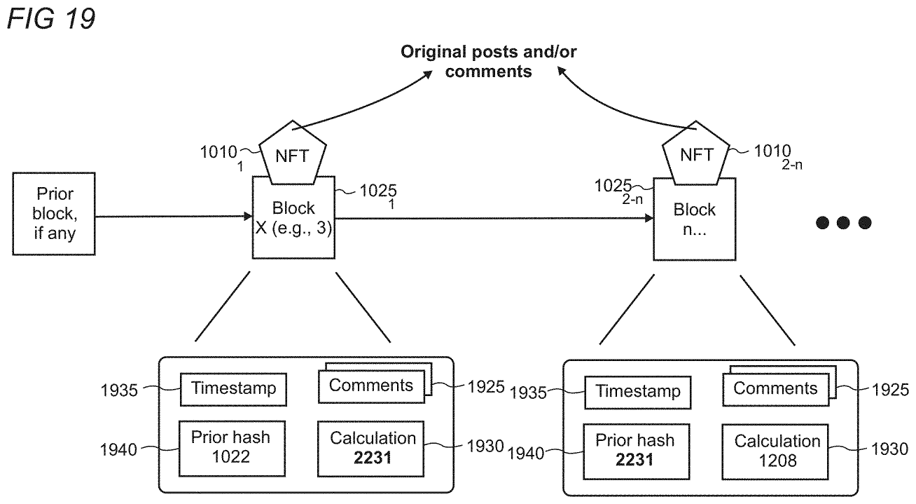

FIG. 19 shows an illustrative representation of an example blockchain with NFTs and associated data. For example, NFTs 1010 are each associated with a given block 1025 on the blockchain. Each block is connected in a chain of blocks on the blockchain to create an immutable ledger. NFTs may represent a social media post, comment, multimedia file, or another piece of data on a social media platform. Each block may be associated with some data, including a timestamp 1935, comments (e.g., comments underneath a post) 1925, a prior hash 1940, and a calculation 1930 specific to that block. The calculation may be calculated based on the calculation from the preceding block in the chain (e.g., prior hash). Thus, for example, the second block in the blockchain's prior hash is 2231, which is the calculation from the preceding block. Such hash functionality helps ensure that the chain is immutable and can be verified by other user devices, or nodes, operating on the blockchain marketplace.

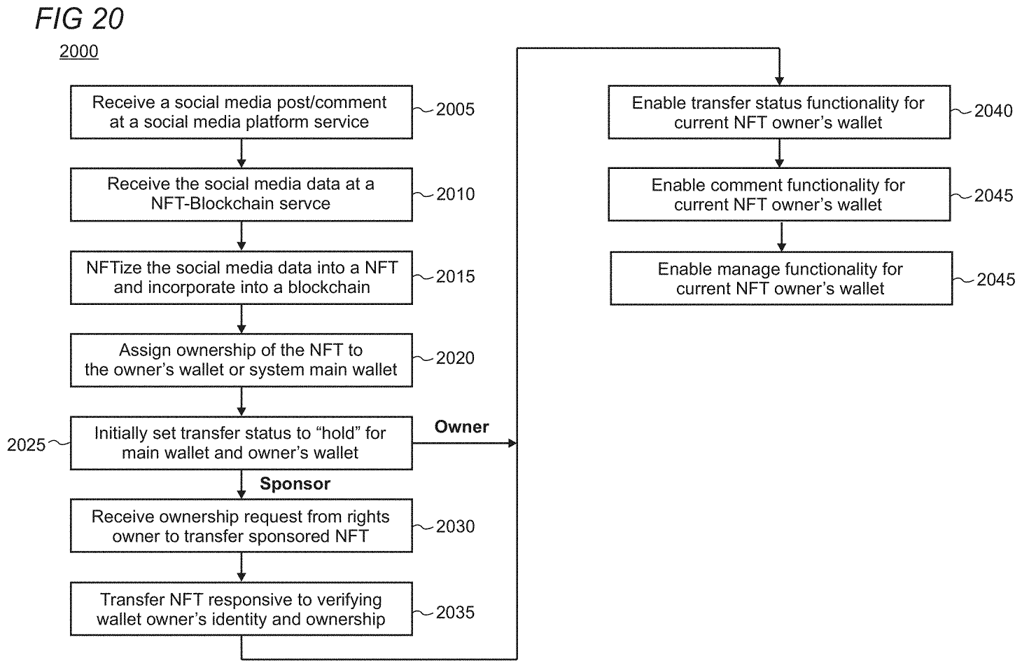

FIGS. 20-23 show various illustrative processes that may be implemented by any one or more of the NFT-Blockchain service 150, social media services 170, or user devices 105. In step 2005, in FIG. 20, a social media platform's service receives a social media post or comment 2005. In step 2010, the NFT-Blockchain service receives the social media data from the social media platform's service, such as the post/comment itself, a timestamp, associated commentary from other users, multimedia files, etc. In step 2015, the NFT-Blockchain service NFTizes the social media data into an NFT and incorporates the minted NFT into a blockchain. In step 2020, the NFT-Blockchain service assigns ownership of the NFT to the owner's wallet or a system main wallet. In step 2025, the NFT-Blockchain service sets the minted NFT's transfer status to “hold” for the owner's wallet and the system main wallet, depending on who the NFT is assigned to.

When the NFT is sponsored and owned by the system main wallet, the NFT-Blockchain service receives an ownership request from the rights owner to transfer the sponsored NFT. In step 2030, the NFT-Blockchain service transfers the NFT responsive to verify the wallet owner's identity and ownership over the NFT.

In step 2040, the NFT-Blockchain service enables transfer status functionality features for the current NFT owner's wallet. If the owner was the owner in step 2025, then step 2040 would be the subsequent step since the owner already has control over their NFT. In step 2045, the NFT-Blockchain service enables comment functionality features for the current NFT owner's wallet. In step 2050, the NFT-Blockchain service enables the owner's wallet to manage the NFT.

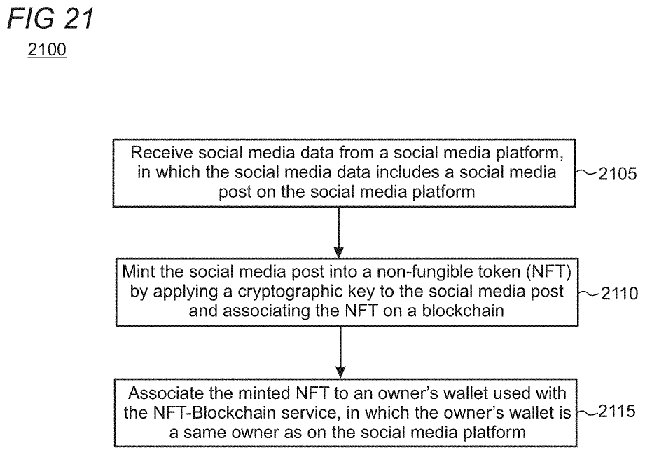

In step 2105, in FIG. 21, the NFT-Blockchain service receives social media data from a social media platform, in which the social media data includes a social media post on the social media platform. In step 2110, the service mints the social media post into a non-fungible token (NFT) by applying a cryptographic key to the social media post and associating the NFT on a blockchain. In step 2115, the service associates the minted NFT to an owner's wallet used with the NFT-Blockchain service, in which the owner's wallet is a same owner as on the social media platform.

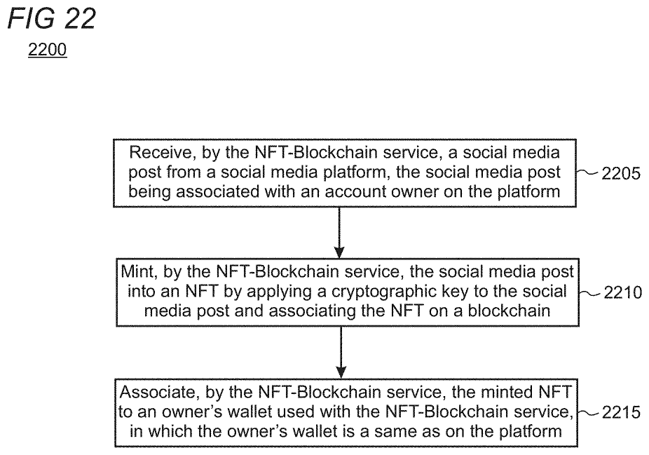

In step 2205, in FIG. 22, the NFT-Blockchain service receives a social media post from a social media platform, the social media post being associated with an account owner on the platform. In step 2210, the service mints the social media post into an NFT by applying a cryptographic key to the social media post and associating the NFT on a blockchain. In step 2215, the service associates the minted NFT to an owner's wallet used with the NFT-Blockchain service, in which the owner's wallet is a same as on the platform.

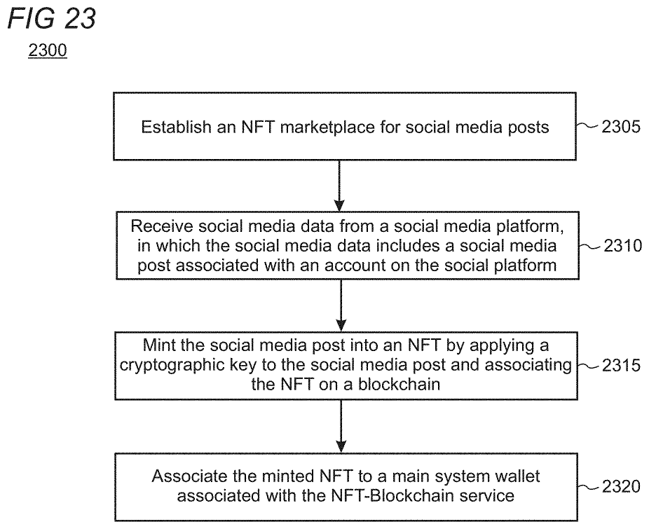

In step 2305, in FIG. 23, the NFT-Blockchain service establishes an NFT marketplace for social media posts. The marketplace includes a dynamic environment in which users possess ownership over social media posts and commentary in an NFT and can offer, sell, purchase, and transfer the NFTs to other interested users/buyers. In step 2310, the service receives social media data from a social media platform, in which the social media data includes a social media post associated with an account on the social media platform. In step 2315, the service mints the social media post into an NFT by applying a cryptographic key to the social media post and associating the NFT on a blockchain. In step 2320, the service associates the minted NFT to a main system wallet associated with the NFT-Blockchain service.

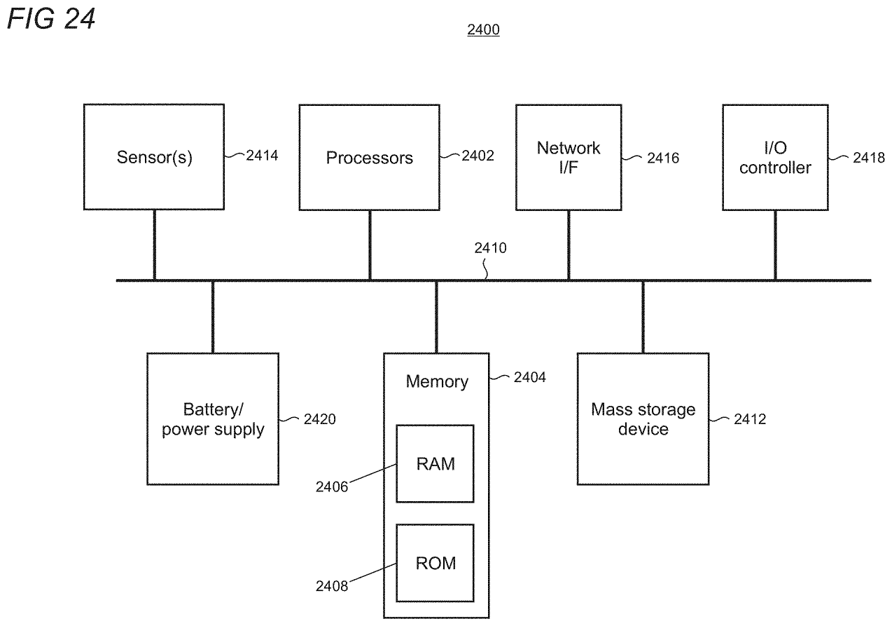

FIG. 24 shows an illustrative diagram of a computer system, such as a smartphone, tablet computer, laptop computer, or desktop computer, that may be utilized to perform the operations herein. The architecture 2400 illustrated in FIG. 24 includes one or more processors 2402 (e.g., central processing unit, dedicated Artificial Intelligence chip, graphics processing unit, etc.), a system memory 2404, including RAM (random access memory) 2406 and ROM (read-only memory) 2408, and a system bus 2410 that operatively and functionally couples the components in the architecture 2400. A basic input/output system containing the basic routines that help to transfer information between elements within the architecture 2400, such as during startup, is typically stored in the ROM 2408. The architecture 2400 further includes a mass storage device 2412 for storing software code or other computer-executed code that is utilized to implement applications, the file system, and the operating system. The mass storage device 2412 is connected to the processor 2402 through a mass storage controller (not shown) connected to the bus 2410. The mass storage device 2412 and its associated computer-readable storage media provide non-volatile storage for the architecture 2400. Although the description of computer-readable storage media contained herein refers to a mass storage device, such as a hard disk or CD-ROM drive, it may be appreciated by those skilled in the art that computer-readable storage media can be any available storage media that can be accessed by the architecture 2400.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVD, HD-DVD (High Definition DVD), Blu-ray, or other optical storage, a magnetic cassette, magnetic tape, magnetic disk storage or other magnetic storage device, or any other medium which can be used to store the desired information and which can be accessed by the architecture 2400.

According to various embodiments, the architecture 2400 may operate in a networked environment using logical connections to remote computers through a network. The architecture 2400 may connect to the network through a network interface unit 2416 connected to the bus 2410. It may be appreciated that the network interface unit 2416 also may be utilized to connect to other types of networks and remote computer systems. The architecture 2400 also may include an input/output controller 2418 for receiving and processing input from a number of other devices, including a keyboard, mouse, touchpad, touchscreen, control devices such as buttons and switches, or electronic stylus (not shown in FIG. 24). Similarly, the input/output controller 2418 may provide output to a display screen, user interface, a printer, or other output device types (also not shown in FIG. 24).

It may be appreciated that the software components described herein may, when loaded into the processor 2402 and executed, transform the processor 2402 and the overall architecture 2400 from a general-purpose computing system into a special-purpose computing system customized to facilitate the functionality presented herein. The processor 2402 may be constructed from any number of transistors or other discrete circuit elements, which may individually or collectively assume any number of states. More specifically, the processor 2402 may operate as a finite-state machine in response to executable instructions contained within the software modules disclosed herein. These computer-executable instructions may transform the processor 2402 by specifying how the processor 2402 transitions between states, thereby transforming the transistors or other discrete hardware elements constituting the processor 2402.

Encoding the software modules presented herein also may transform the physical structure of the computer-readable storage media presented herein. The specific transformation of physical structure may depend on various factors in different implementations of this description. Examples of such factors may include but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

The architecture 2400 may further include one or more sensors 2414 or a battery or power supply 2420. The sensors may be coupled to the architecture to pick up data about an environment or a component, including temperature, pressure, etc. Exemplary sensors can include a thermometer, accelerometer, smoke or gas sensor, pressure sensor (barometric or physical), light sensor, ultrasonic sensor, gyroscope, among others. The power supply may be adapted with an AC power cord or a battery, such as a rechargeable battery for portability.

In light of the above, it may be appreciated that many types of physical transformations take place in the architecture 2400 in order to store and execute the software components presented herein. It also may be appreciated that the architecture 2400 may include other types of computing devices, including wearable devices, handheld computers, embedded computer systems, smartphones, PDAs, and other types of computing devices known to those skilled in the art. It is also contemplated that the architecture 2400 may not include all of the components shown in FIG. 24, may include other components that are not explicitly shown in FIG. 24, or may utilize an architecture completely different from that shown in FIG. 24.

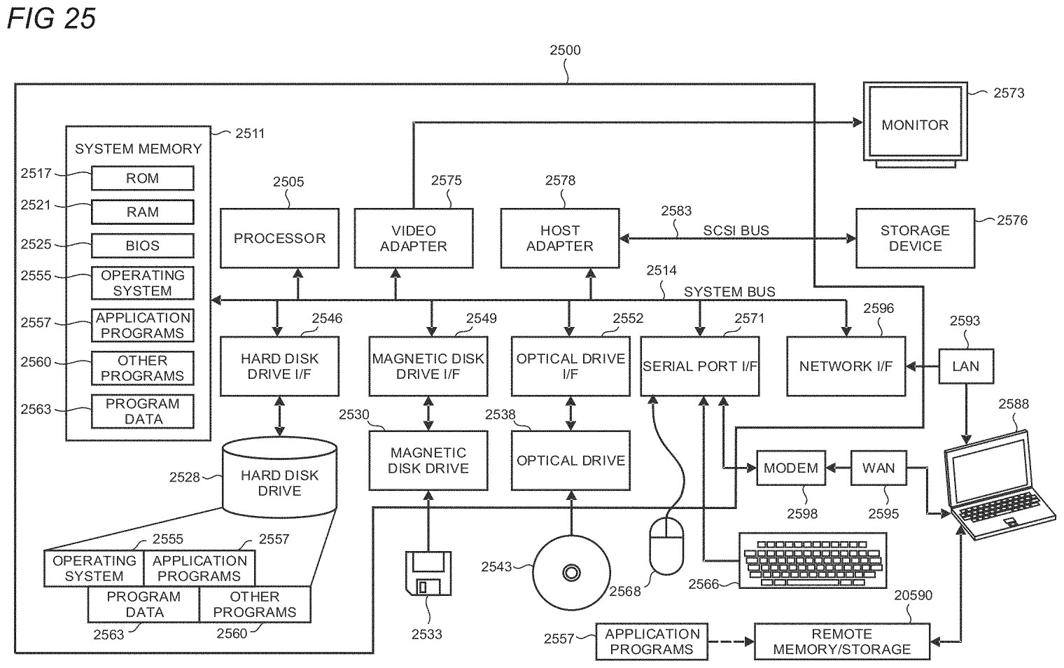

FIG. 25 is a simplified block diagram of an illustrative computer system 2500 such as a server (such as NFT-Blockchain servers or social media platform servers), personal computer, or laptop computer with which the present leveraging NFTs and blockchain to maintain social media content may be implemented.

Computer system 2500 includes a processor 2505, a system memory 2511, and a system bus 2514 that couples various system components including the system memory 2511 to the processor 2505. The system bus 2514 may be any of several types of bus structures, including a memory bus or memory controller, a peripheral bus, or a local bus using any of a variety of bus architectures. The system memory 2511 includes read-only memory (ROM) 2517 and random-access memory (RAM) 2521. A basic input/output system (BIOS) 2525, containing the basic routines that help to transfer information between elements within the computer system 2500, such as during startup, is stored in ROM 2517. The computer system 2500 may further include a hard disk drive 2528 for reading from and writing to an internally disposed hard disk (not shown), a magnetic disk drive 2530 for reading from, or writing to a removable magnetic disk 2533 (e.g., a floppy disk), and an optical disk drive 2538 for reading from or writing to a removable optical disk 2543 such as a CD (compact disc), DVD (digital versatile disc), or other optical media. The hard disk drive 2528, magnetic disk drive 2530, and optical disk drive 2538 are connected to the system bus 2514 by a hard disk drive interface 2546, a magnetic disk drive interface 2549, and an optical drive interface 2552, respectively. The drives and their associated computer-readable storage media provide non-volatile storage of computer-readable instructions, data structures, program modules, and other data for the computer system 2500. Although this illustrative example includes a hard disk, a removable magnetic disk 2533, and a removable optical disk 2543, other types of computer-readable storage media which can store data that is accessible by a computer such as magnetic cassettes, Flash memory cards, digital video disks, data cartridges, random access memories (RAMs), read-only memories (ROMs), and the like may also be used in some applications of the present leveraging non-fungible tokens and blockchain to maintain social media content. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof are intended to cover non-transitory embodiments and do not include waves, signals, and/or other transitory and/or intangible communication media.

A number of program modules may be stored on the hard disk, magnetic disk 2533, optical disk 2543, ROM 2517, or RAM 2521, including an operating system 2555, one or more application programs 2557, other program modules 2560, and program data 2563. A user may enter commands and information into the computer system 2500 through input devices such as a keyboard 2566 and pointing device 2568 such as a mouse. Other input devices (not shown) may include a microphone, joystick, gamepad, satellite dish, scanner, trackball, touchpad, touchscreen, touch-sensitive device, voice-command module or device, user motion or user gesture capture device, or the like. These and other input devices are often connected to the processor 2505 through a serial port interface 2571 that is coupled to the system bus 2514 but may be connected by other interfaces, such as a parallel port, game port, or universal serial bus (USB). A monitor 2573 or other type of display device is also connected to the system bus 2514 via an interface, such as a video adapter 2575. In addition to the monitor 2573, personal computers typically include other peripheral output devices (not shown), such as speakers and printers. The illustrative example shown in FIG. 25 also includes a host adapter 2578, a Small Computer System Interface (SCSI) bus 2583, and an external storage device 2576 connected to the SCSI bus 2583.

The computer system 2500 is operable in a networked environment using logical connections to one or more remote computers, such as a remote computer 2588. The remote computer 2588 may be selected as another personal computer, a server, a router, a network PC, a peer device, or other common network node, and typically includes many or all of the elements described above relative to the computer system 2500, although only a single representative remote memory/storage device 2590 is shown in FIG. 25. The logical connections depicted in FIG. 25 include a local area network (LAN) 2593 and a wide area network (WAN) 2595. Such networking environments are often deployed, for example, in offices, enterprise-wide computer networks, intranets, and the Internet.

When used in a LAN networking environment, the computer system 2500 is connected to the local area network 2593 through a network interface or adapter 2596. When used in a WAN networking environment, the computer system 2500 typically includes a broadband modem 2598, network gateway, or other means for establishing communications over the wide area network 2595, such as the Internet. The broadband modem 2598, which may be internal or external, is connected to the system bus 2514 via a serial port interface 2571. In a networked environment, program modules related to the computer system 2500, or portions thereof, may be stored in the remote memory storage device 2590. It is noted that the network connections shown in FIG. 25 are illustrative, and other means of establishing a communications link between the computers may be used depending on the specific requirements of an application of the present leveraging non-fungible tokens and blockchain to maintain social media content.

Various exemplary embodiments of the present system are disclosed. In one exemplary embodiment, implemented is an NFT (non-fungible token)-Blockchain service configured to facilitate an NFT marketplace for social media data, comprising: one or more processors; one or more hardware-based memory devices storing executable instructions which, when executed by the one or more processors, cause the NFT-Blockchain service to: receive social media data from a social media platform, in which the social media data includes a social media post associated with an account owner of the social media post on the social media platform; mint the social media post into an NFT by applying a cryptographic key to the social media post and associating the NFT on a blockchain; and associate the minted NFT to an owner's wallet used with the NFT-Blockchain service, in which the owner's wallet is a same owner as the account owner on the social media platform.

In another example, the social media post includes any one or more of a written statement, a multimedia file, or a combination thereof. As another example, the executed instructions further cause the NFT-Blockchain service to set a transfer status of the NFT to “hold” upon associating the minted NFT to the owner's wallet. In a further example, the executed instructions further cause the NFT-Blockchain service to set the transfer status of the NFT to “transferrable” responsive to a user request, in which the set transfer status is viewable by other user devices accessing the NFT-Blockchain service to enable purchase and transfer of the NFT. As another example, the executed instructions further cause the NFT-Blockchain service to incorporate comments on the social media post from the social media platform into the NFT. As another example, the executed instructions further cause the NFT-Blockchain service to enable and disable comments on the NFT. In a further example, the executed instructions further cause the NFT-Blockchain service to hide comments for the social media post on the NFT. As another example, the executed instructions further cause the NFT-Blockchain service to deduct a fee from the owner's wallet after minting the social media post into the NFT.

In another exemplary embodiment, implemented is a method executed by an NFT-Blockchain service operating an NFT marketplace for social media posts, comprising: receiving, by the NFT-Blockchain service, a social media post from a social media platform, the social media post being associated with an account owner on the social media platform, in which the social media post comprises any one or more of a written statement, photograph, audio file, or video; minting, by the NFT-Blockchain service, the social media post into an NFT by applying a cryptographic key to the social media post and associating the NFT on a blockchain; associating, by the NFT-Blockchain service, the minted NFT to an owner's wallet used with the NFT-Blockchain service, in which the owner's wallet is a same as the account owner on the social media platform.

In another example, further comprising setting a transfer status of the NFT to “hold” upon associating the minted NFT to the owner's wallet. In another example, further comprising setting the transfer status of the NFT to “transferrable” responsive to a user request, in which the set transfer status is viewable by other user devices accessing the NFT-Blockchain service to enable purchase and transfer of the NFT. In another example, further comprising incorporating comments on the social media post from the social media platform into the NFT. As another example, further comprising enabling and disabling comments on the NFT. As another example, further comprising hiding comments for the social media post on the NFT. As another example, further comprising deducting a fee from the owner's wallet after minting the social media post into the NFT.

In another exemplary embodiment, implemented is one or more hardware-based non-transitory computer-readable memory devices having instructions which, when executed by one or more processors disposed in an NFT-Blockchain service, cause the NFT-Blockchain service to: establish an NFT marketplace for social media data and metadata, including social media posts and its associated metadata; receive social media data and metadata from a social media platform, in which the social media data includes a social media post associated with an account owner of the social media post on the social media platform; mint the social media post into an NFT by applying a cryptographic key to the social media post and associating the NFT on a blockchain; and associate the minted NFT to a main system wallet associated with the NFT-Blockchain service.

In another example, the executed instructions further cause the NFT-Blockchain service to set a transfer status of the NFT to “hold” upon associating the minted NFT to the main system wallet. In another example, the executed instructions further cause the NFT-Blockchain service to: receive a claim from a user wallet having an account with the NFT-Blockchain service; receive a proof of ownership for rights over the NFT; transfer ownership over the NFT to the user wallet that made the claim. As another example, the executed instructions further cause the NFT-Blockchain service to: modify a transfer log associated with the NFT before transferring the NFT; and create a new block on the blockchain based on the ownership transfer from the main system wallet to the user wallet. As another example, the executed instructions further cause the NFT-Blockchain service to enable the user wallet owner to transfer the NFT to a distinct user within the NFT-Blockchain marketplace.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. An NFT (non-fungible token)-Blockchain service configured to facilitate an NFT marketplace for social media data, comprising:
one or more processors;
one or more hardware-based memory devices storing executable instructions which, when executed by the one or more processors, cause the NFT-Blockchain service to:
receive social media data from a social media platform, in which the social media data includes a social media post associated with an account owner of the social media post on the social media platform;
mint the social media post into an NFT by applying a cryptographic key to the social media post and associating the NFT on a blockchain; and
associate the minted NFT to an owner's wallet used with the NFT-Blockchain service, in which the owner's wallet is a same owner as the account owner on the social media platform.

2. The NFT-Blockchain service of claim 1, wherein the social media post includes any one or more of a written statement, a multimedia file, or a combination thereof.

3. The NFT-Blockchain service of claim 1, wherein the executed instructions further cause the NFT-Blockchain service to set a transfer status of the NFT to “hold” upon associating the minted NFT to the owner's wallet.

4. The NFT-Blockchain service of claim 3, wherein the executed instructions further cause the NFT-Blockchain service to set the transfer status of the NFT to “transferrable” responsive to a user request, in which the set transfer status is viewable by other user devices accessing the NFT-Blockchain service to enable purchase and transfer of the NFT.

5. The NFT-Blockchain service of claim 1, wherein the executed instructions further cause the NFT-Blockchain service to incorporate comments on the social media post from the social media platform into the NFT.

6. The NFT-Blockchain service of claim 5, wherein the executed instructions further cause the NFT-Blockchain service to enable and disable comments on the NFT.

7. The NFT-Blockchain service of claim 5, wherein the executed instructions further cause the NFT-Blockchain service to hide comments for the social media post on the NFT.

8. The NFT-Blockchain service of claim 1, wherein the executed instructions further cause the NFT-Blockchain service to deduct a fee from the owner's wallet after minting the social media post into the NFT.

9. A method executed by an NFT-Blockchain service operating an NFT marketplace for social media posts, comprising:
receiving, by the NFT-Blockchain service, a social media post from a social media platform, the social media post being associated with an account owner on the social media platform, in which the social media post comprises any one or more of a written statement, photograph, audio file, or video;
minting, by the NFT-Blockchain service, the social media post into an NFT by applying a cryptographic key to the social media post and associating the NFT on a blockchain;
associating, by the NFT-Blockchain service, the minted NFT to an owner's wallet used with the NFT-Blockchain service, in which the owner's wallet is a same as the account owner on the social media platform.

10. The method of claim 9, further comprising setting a transfer status of the NFT to “hold” upon associating the minted NFT to the owner's wallet.

11. The method of claim 10, further comprising setting the transfer status of the NFT to “transferrable” responsive to a user request, in which the set transfer status is viewable by other user devices accessing the NFT-Blockchain service to enable purchase and transfer of the NFT.

12. The method of claim 9, further comprising incorporating comments on the social media post from the social media platform into the NFT.

13. The method of claim 12, further comprising enabling and disabling comments on the NFT.

14. The method of claim 12, further comprising hiding comments for the social media post on the NFT.

15. The method of claim 9, further comprising deducting a fee from the owner's wallet after minting the social media post into the NFT.

16. One or more hardware-based non-transitory computer-readable memory devices having instructions which, when executed by one or more processors disposed in an NFT-Blockchain service, cause the NFT-Blockchain service to:
establish an NFT marketplace for social media data and metadata, including social media posts and its associated metadata;
receive social media data and metadata from a social media platform, in which the social media data includes a social media post associated with an account owner of the social media post on the social media platform;
mint the social media post into an NFT by applying a cryptographic key to the social media post and associating the NFT on a blockchain; and
associate the minted NFT to a main system wallet associated with the NFT-Blockchain service.

17. The one or more hardware-based non-transitory computer-readable memory devices of claim 16, wherein the executed instructions further cause the NFT-Blockchain service to set a transfer status of the NFT to “hold” upon associating the minted NFT to the main system wallet.

18. The one or more hardware-based non-transitory computer-readable memory devices of claim 16, wherein the executed instructions further cause the NFT-Blockchain service to:
receive a claim from a user wallet having an account with the NFT-Blockchain service;
receive a proof of ownership for rights over the NFT;
transfer ownership over the NFT to the user wallet that made the claim.

19. The one or more hardware-based non-transitory computer-readable memory devices of claim 18, wherein the executed instructions further cause the NFT-Blockchain service to:
modify a transfer log associated with the NFT before transferring the NFT; and
create a new block on the blockchain based on the ownership transfer from the main system wallet to the user wallet.

20. The one or more hardware-based non-transitory computer-readable memory devices of claim 18, wherein the executed instructions further cause the NFT-Blockchain service to enable the user wallet owner to transfer the NFT to a distinct user within the NFT-Blockchain marketplace.
